(19) United States
(12) Patent Application Publication
(10) Pub. No.: US 2017/0136638 A1
(43) Pub. Date: May 18, 2017

(54) SAFETY RAZOR

(71) Applicant: PRESTON HAGE,LLC, Orlando, FL (US)

(72) Inventors: Preston HAGE, Orlando, FL (US); Matthew G. TAYLOR, Orlando, FL (US)

(21) Appl. No.: 15/419,511

(22) Filed: Jan. 30, 2017

Related U.S. Application Data
(63) Continuation-in-part of application No. 14/264,379, filed on Apr. 29, 2014.
Application No. 14/264,379 is a continuation of application No. 13/010,945, filed on Jan. 21, 2011, now Pat. No. 8,745,876.
(60) Provisional application No. 61/297,055, filed on Jan. 21, 2010.

(51) Int. Cl. B26B 21/52; B26B 21/44; B26B 21/40; B26B 21/10

(52) U.S. Cl. CPC B26B 21/521; B26B 21/10; B26B 21/443; B26B 21/4068; B26B 21/525

(57) ABSTRACT

A safety razor includes an elongated handle having an open end, a cartridge head having adjacent angled sections, and first and second blade sets arranged facing away from each other on the adjacent angled sections. The first and second blade sets are orientated generally in parallel with a longitudinal axis of the elongated handle, and the cartridge head has a generally V-shape. The cartridge head is releasable secured to the open end of the elongated handle. In addition, an elastic flexure bearing extends along an apex between the angled sections and joins together the adjacent angled sections. The elastic flexure bearing is comprised of a type of material different than the adjacent angled sections of the cartridge head. The cartridge head includes a base having an upper surface and a lower surface, and a plurality of latching pins coupled to, and extending away from the lower surface of the base.

### CROSS-REFERENCE TO RELATED APPLICATIONS

This application is a continuation-in-part of pending U.S. patent application Ser. No. 14/264,379 filed Apr. 29, 2014, which is a continuation of U.S. patent application Ser. No. 13/010,945 filed Jan. 21, 2011, now U.S. Pat. No. 8,745,876 which claims priority to U.S. provisional application Ser. No. 61/297,055, filed on Jan. 21, 2010, all the contents of which are herein incorporated by reference in their entirety.

### FIELD

The present invention relates to razors, and more particularly, to safety razors with replaceable cartridge heads.

### DESCRIPTION OF THE RELATED ART

Numerous developments and improvements have been made to safety razors in the past several years. However, the general paradigm of the safety razor remains that of a blade head that is oriented perpendicularly to the blade handle, in contradistinction with traditional straight razors, in which the blade extends generally in parallel with the handle. Many shavers prefer the feel and motion offered by a straight razor, but may use a typically safety razor, instead, for fear of serious lacerations or other injury.

### SUMMARY

In view of the foregoing, it is an object of the present invention to provide an improved safety razor. In particular, it is an object of the present invention to provide a safety razor in which the blades are arranged substantially in parallel with a longitudinal axis of the handle.

This and other objects, features, and advantages in accordance with the present invention are provided by a safety razor having an elongated handle having an open end, a cartridge head having adjacent angled sections, and first and second blade sets arranged facing away from each other on the adjacent angled sections. The cartridge head is releasable secured to the open end of the elongated handle. In addition, the safety razor includes an elastic flexure bearing extending along an apex between the angled sections and joining together the adjacent angled sections. The elastic flexure bearing is comprised of a type of material different than the adjacent angled sections of the cartridge head, and the first and second blade sets are orientated generally in parallel with a longitudinal axis of the elongated handle, where the cartridge head has a generally V-shape.

In a particular embodiment, the handle includes a main portion, an overmold portion configured to partially slide over the main portion and have a friction fit, and a release button configured to slide forward to release the cartridge head from the handle. An upper portion of the overmold portion extends beyond an end of the main portion, where the upper portion is comprised of an elastomeric material to cause the cartridge head to flex in all directions.

In a particular embodiment, the cartridge head includes a base having an upper surface and a lower surface, and a plurality of latching pins are coupled to, and extending away from the lower surface of the base. In addition, a center strut is disposed on an underside of the elastic flexure bearing and is coupled to the upper surface of the base to provide structural support for the angled sections so that the angled sections are not directly coupled to the base.

According to a method aspect of the invention, a method of manufacturing a safety razor includes forming a V-shaped cartridge cap having a first upper leg and a second upper leg angled at approximately fifty degrees away from the first upper leg, and the first and second upper legs joined together along a respective inner edge by an elastic flexure bearing. The method also includes applying a force to flatten the cartridge cap and place the elastic flexure bearing under tension, loading a plurality of blade sets and applicant strips into a base portion of the cartridge head, and securing the cartridge cap over the base portion to secure the blade sets and applicant strips in place. In addition, the method includes releasing the force from the cartridge cap so that the elastic flexure bearing causes the cartridge cap to return to its V-shape.

### BRIEF DESCRIPTION OF THE DRAWINGS

FIG. 1 is a top perspective view of a safety razor according to an embodiment of the present invention;

FIG. 2 is a bottom perspective view of the safety razor;

FIG. 3 is a top perspective view of the safety razor with a cartridge head removed from a handle of the safety razor;

FIG. 4 is an exploded view of the handle of the safety razor;

FIG. 5 is a longitudinal cross sectional view of the safety razor;

FIG. 6 is a perspective rear view of the cartridge head of the safety razor;

FIG. 7 is a perspective front view of the cartridge head of the safety razor;

FIG. 8 is a rear plan view of the cartridge head;

FIG. 9 is a front plan view of the cartridge head;

FIG. 10 is an elevational view of the cartridge head;

FIG. 11 is an end view of the cartridge head;

FIG. 12 is a cross sectional view of a cartridge cap of the cartridge head;

FIG. 13 is a cross sectional view of the cartridge cap flattened prior to loading blades and applicant strips into a bottom portion of the cartridge head;

FIG. 14 is a cross sectional view of the cartridge cap secured over the bottom portion of the cartridge head with the blades secured in place; and

FIG. 15 is a cross sectional of the assembled cartridge head.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

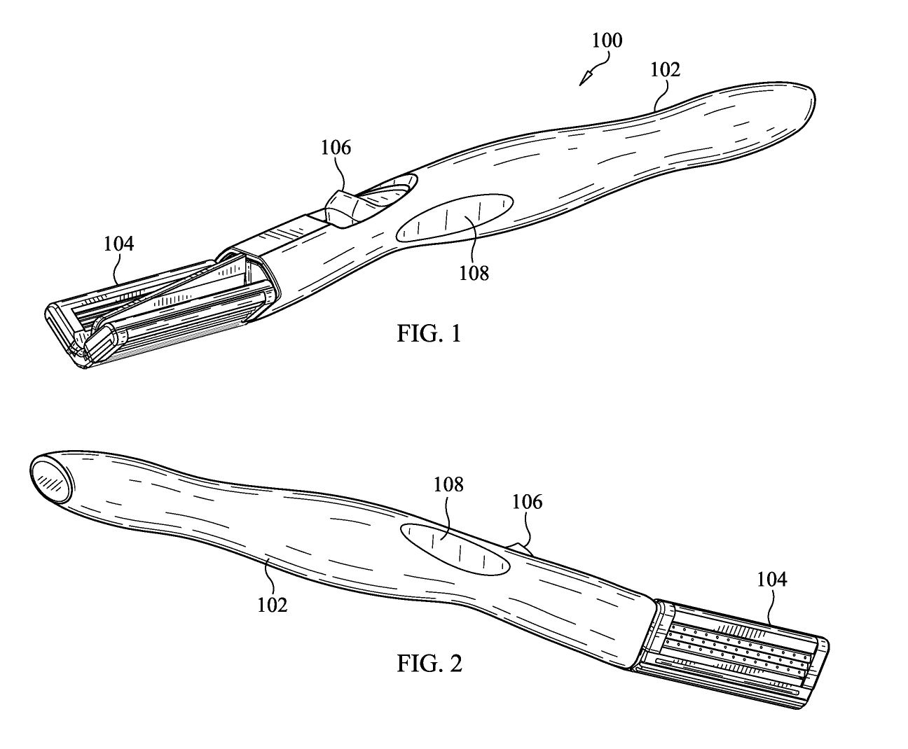

Referring now to FIGS. 1 and 2, according to an embodiment of the present invention, a safety razor 100 includes a cartridge head 104 and a handle 102. The cartridge head 104 is releasably secured to the handle 102 using a release button 106 of the handle 102. The handle 102 includes grip areas 108 that are configured to be used to assist a user to grip the handle 102.

The cartridge head 104 has a generally V-shape and includes a first set and a second set of blades. The first set of blades is secured to a first leg of the cartridge head 104 and the second set of blades is secured to a second leg of the cartridge head 104 (described in more detail below). As a result, the safety razor 100 is readily usable with either hand of the user to shave both with and against the grain. The first and second sets of blades are arranged generally parallel and angled to cut using a downward motion.

In addition, the cartridge head 104 may include an applicant strip. The applicant strip may include one or more consumable compounds, for instance skin moisturizers and lubricants. The applicant strip may be secured above each of the first and second blade sets, such that the compounds are applied directly after hairs are cut. Additionally, the applicant strip may include an indicator mechanism, such as a color layer that will be depleted with use, to indicate when replacement of cartridge head 104 should be performed.

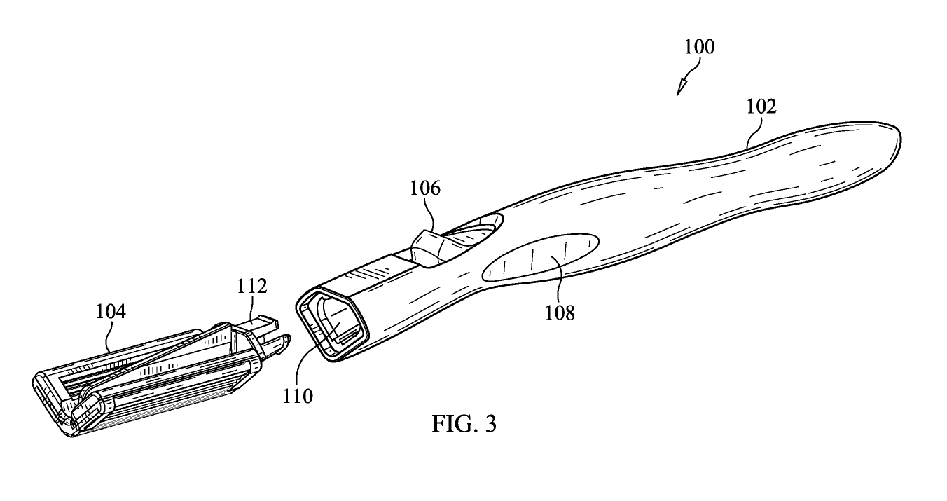

Referring now to FIG. 3, the cartridge head 104 includes latch pins 112 on a first end that are used to releasable secure the cartridge head 104 to the handle 102. In particular, the latch pins 112 are configured to slide into an open end 110 of the handle 102 and engage the handle 102. Preferably, the cartridge head 104 is substantially equal in diameter to the handle 102.

A release button 106 communicates with the latch pins 112 to selectively disengage the latch pins 112 from the handle, allowing removal of the cartridge head 104 from the handle 102.

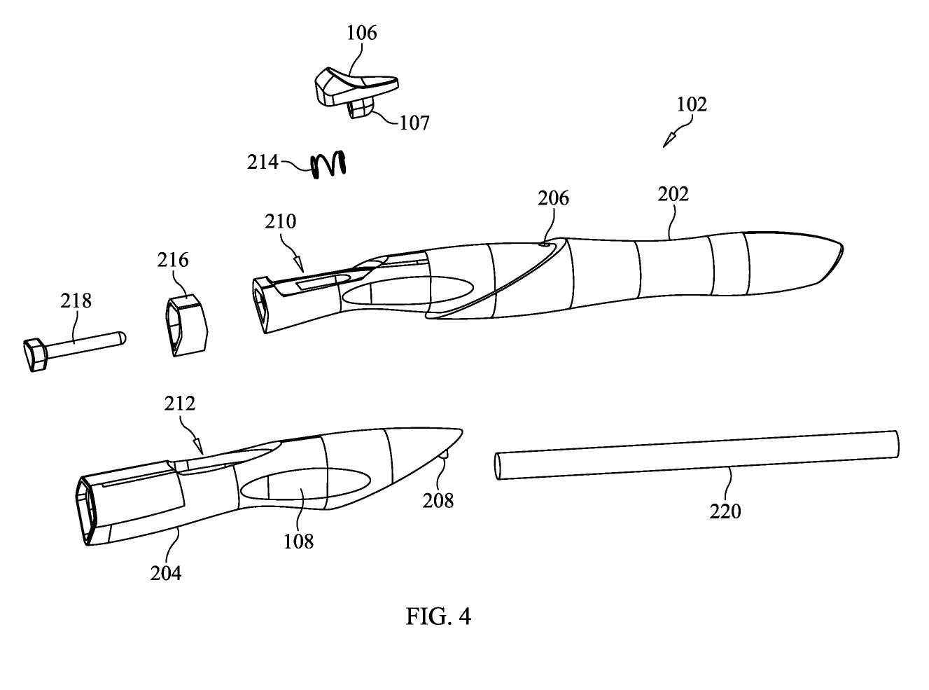

Referring now to FIG. 4, an exploded view of the handle 102 is shown. The handle 102 includes a main portion 202 and an overmold portion 204. The overmold portion 204 is configured to partially slide over the main portion 202 and have a friction fit. In a particular embodiment, the overmold portion 204 includes a peg 208 proximate an end of the overmold portion 204, where the peg 208 is configured to slide into, and engage, an aperture 206 formed in the main portion 202. Once the peg 208 is engaged with the aperture 206, the overmold portion 204 is secured to the main portion 202 of the handle 102 and prevents the overmold portion 204 from sliding off the main portion 202.

A cavity 210 is formed in the main portion 104 of the handle 102 and is configured to receive the release button 106 and a spring 214. The release button 106 is configured to slide back and forth within the cavity 210. An access aperture 212 is formed in the overmold portion 204 of the handle 202 and is configured so that the user can access the release button 106 and slide it forward to release the cartridge head 104 from the handle 102.

A cartridge head holder 216 is configured to engage the base of the cartridge head 104. The cartridge head holder 216 is comprised of a first type of material and the overmold portion 204 is comprised of a second type of material. In particular, the first type of material of the main portion 202 and the cartridge head holder 216 is relatively rigid and may be comprised of an ABC/PC blend of material and produced by injection molding. The second type of material of the overmold portion 204 may be elastomeric and relatively elastic and may comprise TPE 40A durometer material and produced by injection molding. A dowel 220 may be molded into the main portion 202 to add structural strength to the handle 102.

A cartridge pusher 218 is configured for a first end to be engaged by a lower protrusion 107 of the release button 106 and a second end is configured to engage the latch pins 112 of the cartridge head 104. In use, the user pushes the release button 106 forward and pushes on the latch pins 112 outward from the handle 102, which causes the latch pins 112 to release and allows the cartridge head 104 to be removed from the handle 102.

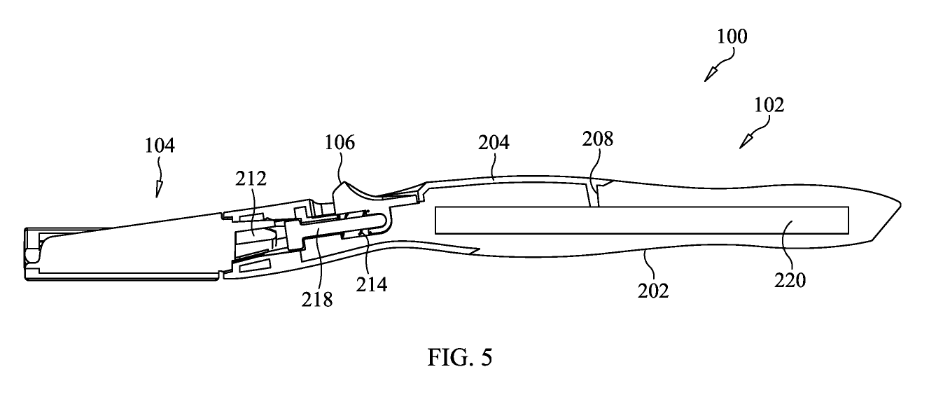

An upper portion of the overmold portion 204 extends beyond an end of the main portion 202 when secured together as shown in FIG. 5. Accordingly, the upper portion of the overmold portion 204 has an elastomeric property and is configured to flex such that pivotal motion induced by shaving with either side of the cartridge head 104 will be resisted by the upper portion of the overmold portion 204. The attachment point of the handle 102 to the cartridge head comprises a type of material that is configured to flex in approximately thirty degrees in all directions. Also, the cartridge head 104 will automatically return to its neutral position when pressure is removed from applying the cartridge head 104 to the skin of the user.

It will be appreciated that different interfaces could be used to allow pivotal and flexure motion between the cartridge head 104 and the handle 102, as well as rigid and/or integral connections. Additionally, components could be interchanged between the cartridge head 104 and the handle 102. For example, the handle 102 could include the latching pins 112 and extend from the handle 102 to engage an open end of the cartridge head 104.

During operation, a user loads a new cartridge head 104 onto the handle 102 by inserting the latching pins 112 into the open end of the handle 102. The latching pins 112 are automatically biased into engagement with the handle 102 and retain the latching pins 112 within the open end of the handle 102.

Referring now to FIGS. 6-11, the cartridge head 104 is shown removed from the handle 102. The first and second blade sets, collectively 312, are arranged facing away from each other on adjacent angled sections 302, 304 of the cartridge head 104, with an elastic flexure bearing 310 extending along an apex of the angled sections 302, 304.

The latching pins 112 are connected to, and extend away from a lower surface of a base 308 of the cartridge head 104. A center strut 306 is disposed on an underside of the elastic flexure bearing 310 and is coupled to an upper surface of the base 308. The center strut 306 provides the support for the angled sections 302, 304 and the blade sets 312.

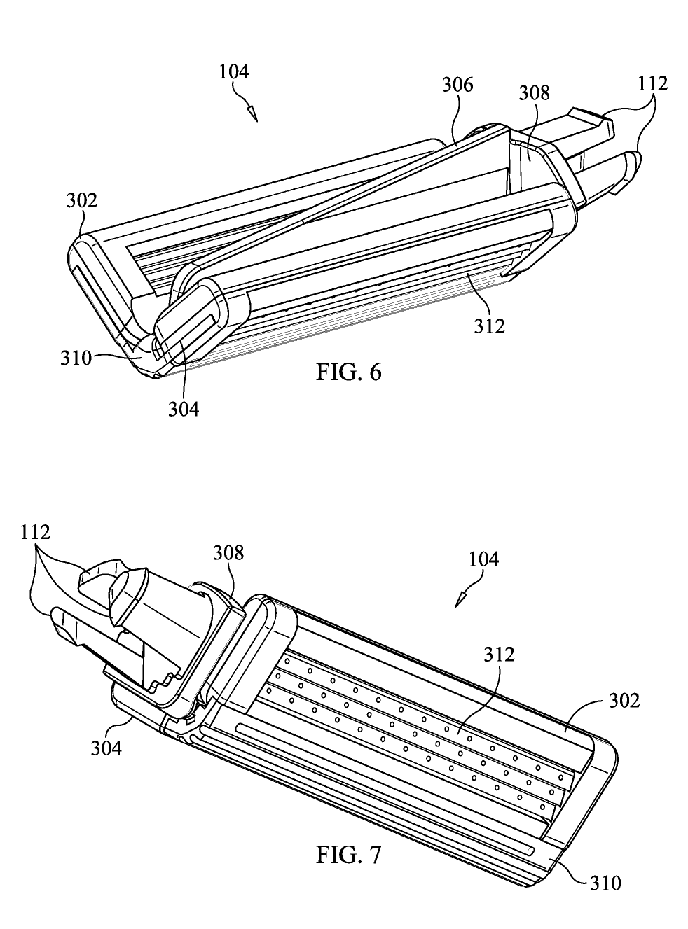

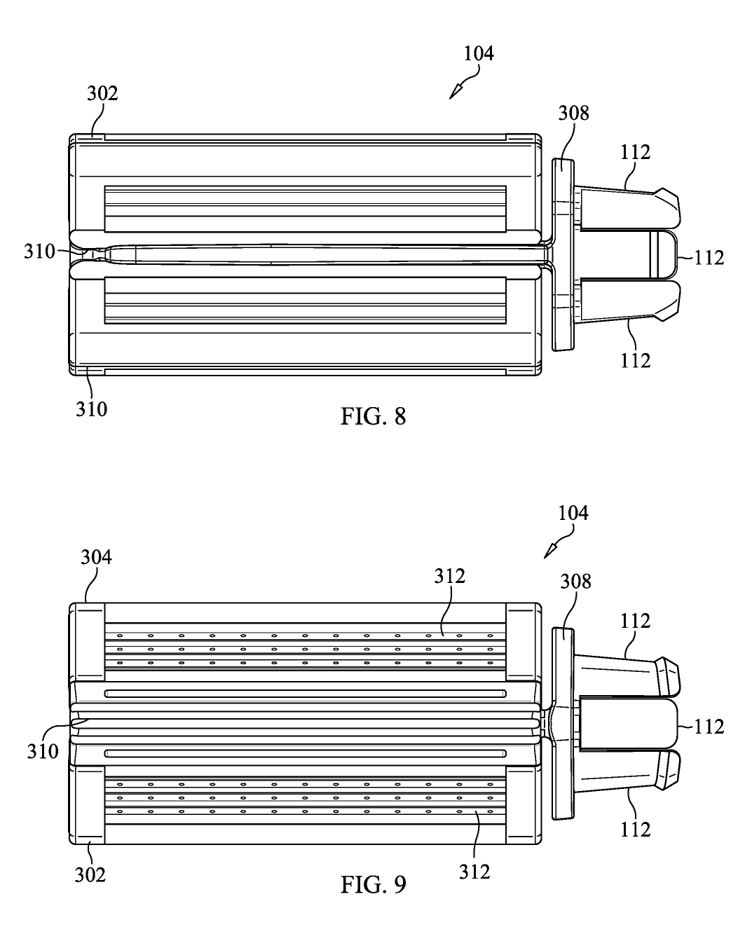

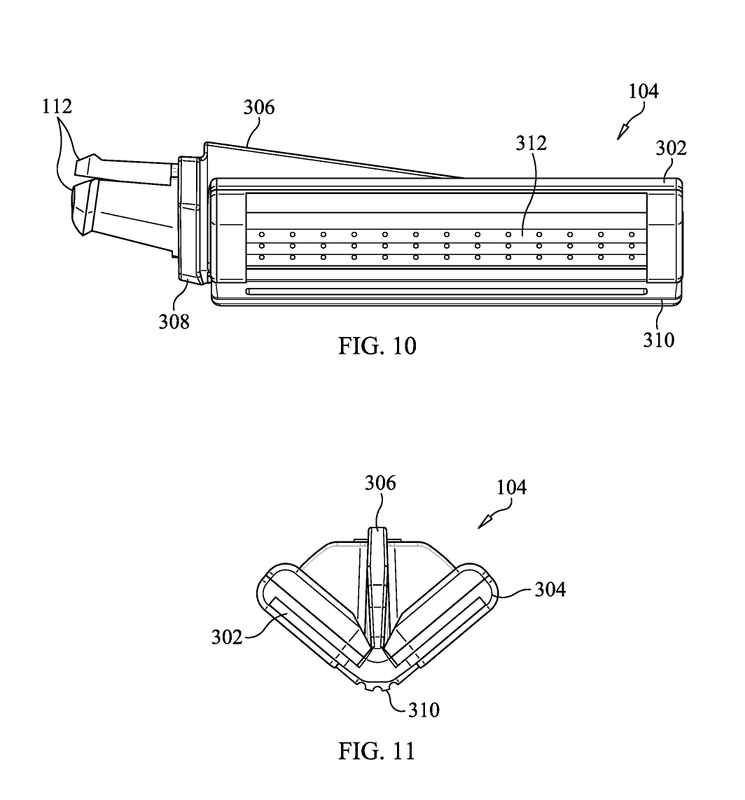

Accordingly, the angled sections 302, 304 are not directly coupled to the base 308 so that the angled sections 302, 304 can flex independently when pressure is applied when shaving. This is best illustrated in FIGS. 8 and 9 that show the spacing between the platform 308 and a bottom edge of the angled sections 302, 304. FIG. 10 illustrates that the center strut 306 is directly coupled to the upper surface of the base 308. The elastic flexure bearing 310 is comprised of an elastic type of material, for example an elastomeric material, which is different than the type of material that comprises the angled sections 302, 304.

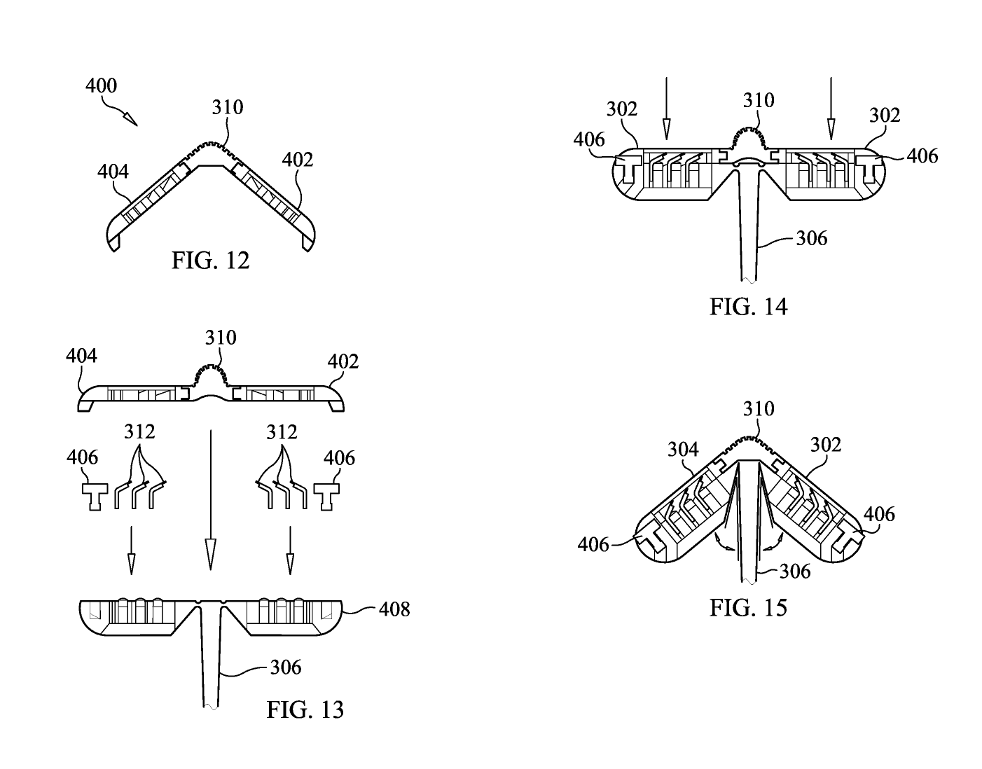

Referring now to FIGS. 12-15, the various stages of manufacturing the cartridge head 104 are shown. For example, FIG. 12 is a cross sectional view of a cartridge cap 400 for the cartridge head 104. The cartridge cap 400 includes a first upper leg 402 and a second upper leg 404. Each upper leg 402, 404 is angled at approximately fifty degrees from center and joined together along a respective inner edge by the elastic flexure bearing 310 described above. The cartridge cap 400 is then flattened as shown in FIG. 13, and the elastic flexure bearing 310 is placed under tension. The blade sets 312 and applicant strips 406 are then loaded into a base portion 408 of the cartridge head 104. The cartridge cap 400 can then be sonic welded, snapped or glued to the base portion 408 to secure the blade sets 312 and applicant strips 406 in place.

Once the cartridge cap 400 is secured to the base portion 408, the cartridge cap 400 is released and the elastic flexure bearing 310, which is under tension, snaps back towards its neutral position. The first and second legs 302, 304 are configured to flex about the elastic flexure bearing 310 approximately thirty degrees inwards towards the center strut 306.

The blade sets 312 each include at least one blade, and preferably a plurality of blades. The cutting edge of each blade in the blade sets 312 is angled away from the applicant strips 406. As explained above, the applicant strips 406 include one or more consumable compounds, for instance skin moisturizers and/or lubricants. The applicant strips 406 can be formed as a reservoir holding a flowable compound which exits the reservoir through a surface membrane due to expansion of the compound in the presence of water. Alternately, the applicant strips 406 can be formed as a solid strip that, in contact with moisture, forms a flowable compound. An indicator mechanism can be incorporated into each of the applicant strips 406 to indicate when replacement of the cartridge head 104 is recommended.

The components of the safety razor 100 are preferably fabricated from metal and/or plastics, as appropriate. The blade sets 312 are preferably a high-grade stainless steel or other corrosion-resistant material capable of retaining a razor edge. The applicant strips 406 can be comprised of substances as described above.

The safety razor 100 is preferably supplied to the user with the handle 102 fully assembled and the cartridge head 104 attached thereto and/or included in a kit therewith. As explained above, to attach the cartridge head 104, the latching pins 112 and open end 110 of the handle 104 are aligned, and the latching pins 112 are slid into the handle 102 until the latching pins 112 are engaged with the handle 102.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A safety razor comprising:
an elongated handle having an open end;
a cartridge head having adjacent angled sections;
first and second blade sets arranged facing away from each other on the adjacent angled sections, the cartridge head releasable secured to the open end of the elongated handle; and
an elastic flexure bearing extending along an apex between the angled sections and joining together the adjacent angled sections.

2. The safety razor of claim 1, wherein the elastic flexure bearing is comprised of a type of material different than the adjacent angled sections of the cartridge head.

3. The safety razor of claim 1, wherein the first and second blade sets are orientated generally in parallel with a longitudinal axis of the elongated handle.

4. The safety razor of claim 1, wherein the cartridge head has a generally V-shape.

5. The safety razor of claim 1, wherein the handle comprises:
a main portion; and
an overmold portion configured to partially slide over the main portion and have a friction fit.

6. The safety razor of claim 1, wherein the handle comprises a release button configured to slide forward to release the cartridge head from the handle.

7. The safety razor of claim 1, wherein the cartridge head comprising:
a base having an upper surface and a lower surface;
a plurality of latching pins coupled to, and extending away from the lower surface of the base; and
a center strut disposed on an underside of the elastic flexure bearing and coupled to the upper surface of the base to provide structural support for the angled sections so that the angled sections are not directly coupled to the base.

8. The safety razor of claim 1, wherein the elastic flexure bearing comprises an elastomeric material that is different than the type of material that comprises the angled sections.

9. The safety razor of claim 1, wherein razor edges of the first and second blade sets are both oriented away from the apex.

10. The safety razor of claim 1, wherein the angled sections are offset greater than ninety degrees.

11. The safety razor of claim 1, wherein the cartridge head comprises an applicant strip extending along a free edge of each of the first and second blade sets.

12. The safety razor of claim 5, further comprising:
a peg proximate an end of the overmold portion; and
an aperture formed in the main portion, wherein the peg is configured to slide into, and engage, the aperture formed in the main portion.

13. The safety razor of claim 5, wherein an upper portion of the overmold portion extends beyond an end of the main portion, the upper portion comprised of an elastomeric material to cause the cartridge head to flex in all directions.

14. A safety razor comprising:
a cartridge head having adjacent angled sections;
first and second blade sets arranged facing away from each other on the adjacent angled sections; and
an elastic flexure bearing extending along an apex between the angled sections and joining together the adjacent angled sections.

15. The safety razor of claim 14, wherein the elastic flexure bearing is comprised of a type of material different than the adjacent angled sections of the cartridge head.

16. The safety razor of claim 14, wherein the cartridge head has a generally V-shape.

17. The safety razor of claim 14, wherein the cartridge head comprising:
a base having an upper surface and a lower surface;
a plurality of latching pins coupled to, and extending away from the lower surface of the base; and
a center strut disposed on an underside of the elastic flexure bearing and coupled to the upper surface of the base to provide structural support for the angled sections so that the angled sections are not directly coupled to the base.

18. The safety razor of claim 14, wherein the elastic flexure bearing comprises an elastomeric material that is different than the type of material that comprises the angled sections.

19. The safety razor of claim 14, wherein razor edges of the first and second blade sets are both oriented away from the apex.

20. A method of manufacturing a safety razor, the method comprising:
forming a V-shaped cartridge cap having a first upper leg and a second upper leg angled at approximately fifty degrees away from the first upper leg, and the first and second upper legs joined together along a respective inner edge by an elastic flexure bearing;
applying a force to flatten the cartridge cap and place the elastic flexure bearing under tension;
loading a plurality of blade sets and applicant strips into a base portion of the cartridge head;
securing the cartridge cap over the base portion to secure the blade sets and applicant strips in place; and
releasing the force from the cartridge cap so that the elastic flexure bearing causes the cartridge cap to return to its V-shape.
